(19) United States
(12) Patent Application Publication
(10) Pub. No.: US 2009/0287862 A1
(43) Pub. Date: Nov. 19, 2009

(54) Host device and scheduling method

(75) Inventor: Makoto Satoh, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,987

(22) Filed: Mar. 5, 2009

(30) Foreign Application Priority Data
May 16, 2008 (JP) 129414/2008

(51) Int. Cl. G06F 3/00

(52) U.S. Cl. 710/58

(57) ABSTRACT

In order to achieve an improved efficiency for a system in which a host device specifies a time slot for data transfer from a device to the host device, a scheduling unit of the host device performs scheduling and allocates, to the device, a time slot having a length of a shortest time period which is necessary for the device to perform the data transfer to the host device normally. When errors have occurred continuously in receiving data transferred from the device, the scheduling unit temporarily extends a slot length which is to be specified for the device.

### BACKGROUND OF THE INVENTION

1. Field of the Invention

The present invention relates to a scheduling technology which specifies a time slot for data transfer from a device to a host device.

2. Description of the Related Art

There exist several standards in which data transfer by a device is scheduled by a host device, and the device performs the data transfer in accordance with the scheduling. With regard to systems compliant with such standards, there have been proposed control methods for data transfer from various points of view.

For example, JP 2003-199152 A discloses a method which, in a system compliant with the Bluetooth standard, changes a packet type for data transfer in accordance with a packet error rate so as to improve the transfer efficiency.

Apart from the Bluetooth, there is another standard called wireless universal serial bus (WUSB), which is expected to attract attention as an interface for a personal computer (hereinbelow, referred to as PC). A WUSB network has such a structure in which a host device controls timing of data transmission, and a device responds to a data transmission request from the host device, thereby performing the data transmission.

The connection mode for the WUSB network is a hub-and-spoke model, in which devices are connected to a host device (e.g., PC) located at the center. Communication between the host device and each device is point-to-point (PnP), in which a connection is made one-to-one. The devices are, for example, a printer, a hard disk, a mouse, a digital camera, a game console, and a PDA.

In a WUSB cluster (hereinbelow, also referred to simply as cluster) having a host device and devices connected together in accordance with the WUSB standard, the host device manages the cluster (including devices in cluster) by using a micro-scheduled management command (MMC).

The MMC is issued from the host device at a timing which is determined on the host device side. The MMC contains identification information of the host device, an issuance time of the subsequent MMC, and the like.

In the WUSB system, the host device takes the initiative in data transmission between the host device and devices in the cluster. With respect to a plurality of devices which perform data transmission with the host device, the host device carries out scheduling by allocating a time slot during which each of the devices transmits/receives data, and makes a data transmission request to each device via the MMC in accordance with the scheduling.

Specifically, when requesting a device to transmit data, the host device transmits a WdtCTA (dt: data transmit) via an MMC. The WdtCTA contains identification information of the device which is requested to transmit data, and information specifying a start time and a finish time of transmission performed by the device. Hereinbelow, the start time and the finish time of transmission performed by the device are referred to as slot specifying information.

A device requested to transmit data divides the data by the packet, and then transmits the divided data to the host device during the time slot specified by the slot specifying information.

In the WUSB standard, the length of a time slot, which is specified for a device by the host device, is determined based on such factors as the data length and the transfer rate. When the host device schedules data transmission for a device, it is necessary to secure a slot long enough to transfer a packet, which is calculated based on the data length contained in the packet and the transfer rate.

Further, the maximum length of data which can be contained in one packet by a device is specified as a “MaxPacketSize” by the host device. Specifically, in calculating the length of a time slot, which is specified when the host device requests a device to transmit one packet, it is always possible to secure a sufficient slot length by performing calculation on the assumption that the data length contained in the packet is the “MaxPacketSize”.

However, a time period which it takes to transfer a packet having a data length shorter than the “MaxPacketSize” (ShortPacket) is shorter than a time period calculated based on the above-mentioned “MaxPacketSize”. If a time slot is always specified as the data maximum length of one packet for a device, the time slot is wasted in a situation in which “ShortPacket” transfer is performed relatively frequently. Therefore, there arises a problem that a decline in transfer efficiency occurs.

### SUMMARY

According to an aspect of the present invention, there is provided a host device. The host device includes a scheduling unit which specifies a time slot for transferring data to the host device from a device connected to the host device and a receiving unit which receives the data transferred from the device during the time slot specified by the scheduling unit. The scheduling unit specifies a length of the time slot as a shortest time period necessary for the device to transfer the data normally.

It should be noted that such an expression that replaces the device of the above-mentioned aspect with a method, a system, or a program that causes a computer to operate as the device of the above-mentioned aspect is also effective as another aspect of the present invention.

With the technology of the present invention, it is possible to achieve an improved efficiency for a system in which the host device specifies the time slot for the data transfer from the device to the host device.

### BRIEF DESCRIPTION OF THE DRAWINGS

In the accompanying drawings:

FIG. 1 is a diagram illustrating a WUSB system according to an embodiment of the present invention;

FIG. 2 is a diagram illustrating a host device of the WUSB system illustrated in FIG. 1;

FIG. 3 is a flow chart illustrating processing relating to scheduling performed by the host device illustrated in FIG. 2;

FIG. 4 is a diagram illustrating a problem inherent in a case of setting a slot length to a maximum length; and

FIG. 5 is a diagram exemplifying a relation between a slot length specified by the host device illustrated in FIG. 2 and a time period necessary for a device to perform data transfer to the host device.

### DETAILED DESCRIPTION OF THE PREFERRED EMBODIMENT

Hereinbelow, referring to the drawings, an embodiment of the present invention is described. It should be noted that the components which are illustrated, as functional blocks for performing various kinds of processing, in the drawings used for description below can be configured by a processor, a memory, and other circuits in terms of hardware, and, in terms of software, can be implemented by programs recorded or loaded into memories. Accordingly, as is well understood by those skilled in the art, such functional blocks can be implemented in a variety of forms, such as in a form of hardware alone, in a form of software alone, and in a form of combination thereof. The implementation of such functional blocks is not limited to any one particular form.

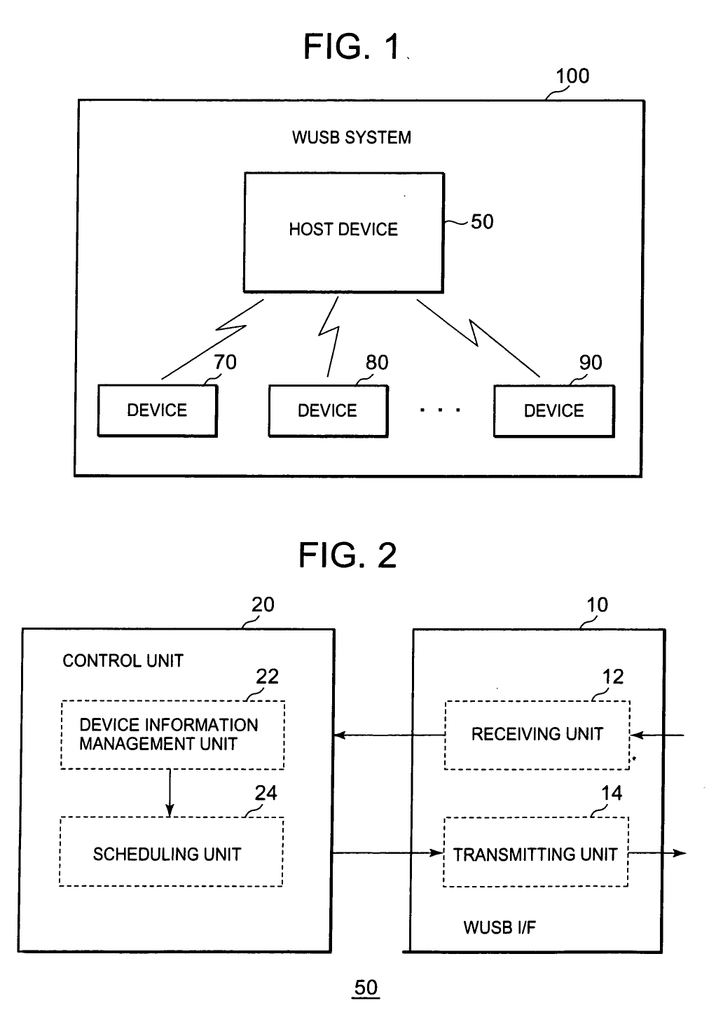

FIG. 1 illustrates a wireless universal serial bus (WUSB) system 100 according to the embodiment of the present invention. The WUSB system 100 includes a host device 50 and a plurality of devices (three devices in the illustrated example: device 70, device 80, and device 90).

The device 70, the device 80, and the device 90 are compliant with WUSB standard, and are, for example, a printer, a hard disk, a mouse, a digital camera, a game console, and a PDA, which are used by establishing wireless connection with the host device 50. Those devices are typical devices for a WUSB system, which are mounted with hardware and software compliant with the WUSB standard, and hence detailed description thereof is omitted.

The host device 50 is, for example, a personal computer, and is compliant with the WUSB standard. Referring to FIG. 2, the host device 50 is described. It should be noted, hereinbelow, in order for the gist of the present invention to be easily understood, that only portions which handle processing relevant to the present invention are described and illustrated.

As illustrated in FIG. 2, the host device 50 includes a WUSB interface (hereinbelow, referred to as WUSB I/F) 10 and a control unit 20.

The WUSB I/F 10 is compliant with the WUSB standard, and, in accordance with the WUSB standard, data transmission is carried out between the host device 50 and each device. The WUSB I/F 10 includes a receiving unit 12 for receiving data, a connection request, and the like, which are sent to the host device 50 from each device, and a transmitting unit 14 for transmitting data, a transmission request (including slot specifying information), and the like, which are sent to each device from the host device 50.

The control unit 20 controls connection and data transmission/reception between the host device 50 and each device. The control unit 20 includes a device information management unit 22 and a scheduling unit 24. It should be noted that the host device 50 is mounted with a driver (not shown), and the driver specifies a “MaxPacketSize”, a data length of transfer data, and a data transfer rate (53.3 MHz to 480 MHz). The driver receives a request for the data length of transfer data from an upper driver (class driver), application software, and the like.

The device information management unit 22 manages information such as identification information and an attribute of each connected device, and provides the information to the scheduling unit 24. Further, when errors occur during reception from a device, the device information management unit 22 performs processing of counting the number of errors which have occurred continuously. Hereinbelow, the number of continuous errors counted by the device information management unit 22 is referred to as an “error count value”.

The scheduling unit 24 refers to device information (including error count value) managed by the device information management unit 22 to thereby perform scheduling. Prior to detailed description of processing performed by the scheduling unit 24, the length of a time slot, which the host device 50 specifies for a device in the WUSB system 100, is first described.

Elements used by the host device 50 for determining the length of a time slot include the “MaxPacketSize”, the data length of transfer data, the number of transfer packets, and the data transfer rate (53.3 MHz to 480 MHz). The above-mentioned driver specifies the “MaxPacketSize” and the data transfer rate based on the support area of the device and the state of the communication environment. Further, the driver makes a request for the data length of transfer data in accordance with a request from the upper class driver, the application software, or the like. In some cases, the data length takes a value of “integral multiple of MaxPacketSize+ShortPacket”, and, in other cases, the data length takes a value less than the “MaxPacketSize”.

When the data length requested from the driver is longer than the “MaxPacketSize”, the host device 50 divides the data length by the “MaxPacketSize”, and then makes a data transfer request with a plurality of packets having the size of the “MaxPacketSize”. Further, when the host device 50 performs the scheduling, the length of a time slot, which is to be specified for the device, is calculated based on the “MaxPacketSize” at that point, a remainder value of the data length requested from the driver, and the like.

In the WUSB system 100 according to this embodiment, when a slot is specified for a device by issuing a WdtCTA (dt: data transmit) in the initial state, based on the above-mentioned elements, the scheduling unit 24 sets the length of a slot to a shortest time period obtained when the device performs data transfer normally to the host device 50. At the time of scheduling thereafter, the length of a slot, which is to be specified for the device, is determined based on the error count value of the device as well as the above-mentioned factors.

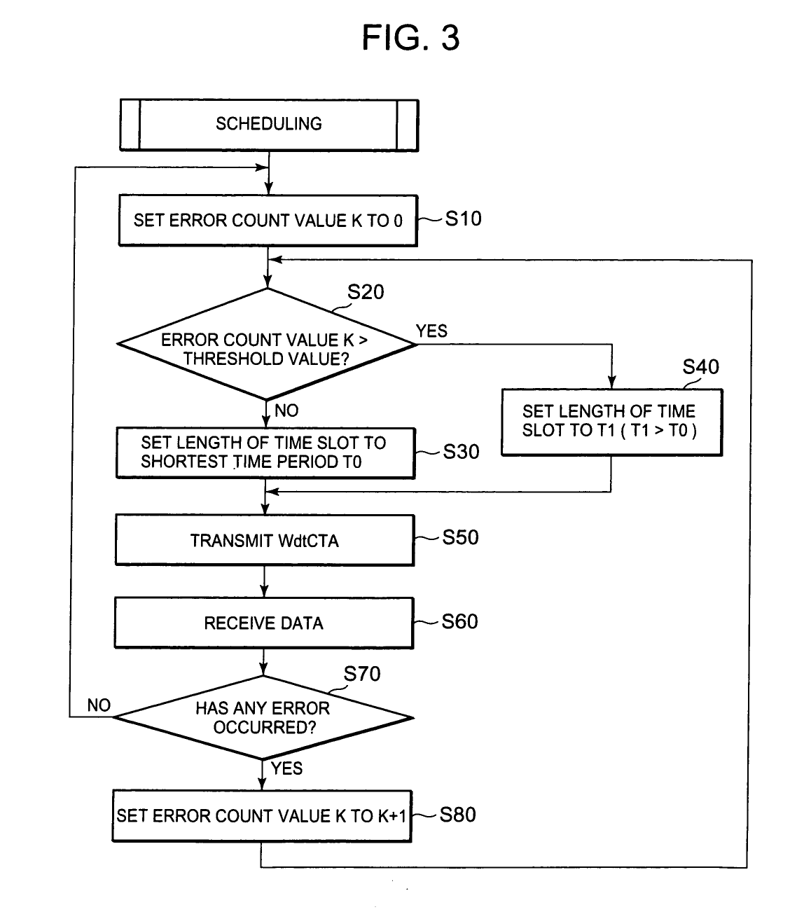

FIG. 3 is a flow chart which illustrates processing relating to the scheduling performed by the host device 50. Immediately after the establishment of connection with a device, the device information management unit 22 sets a reception error count value K of the device to 0 (S10). In creating the slot specifying information (contained in WdtCTA), the scheduling unit 24 refers to the reception error count value K of the device, which is managed by the device information management unit 22. Then, when the reception error count value K is equal to or less than a predetermined threshold value (e.g., 3), the above-mentioned shortest time period (in description and illustration below, denoted by T0) is calculated, and then the length of a time slot, which is to be specified for the device and contained in the slot specifying information, is set to a shortest time period T0 (S20: No, S30). On the other hand, when the reception error count value K exceeds the predetermined threshold value, the scheduling unit 24 sets the length of a time slot, which is to be specified for the device, to a time period T1, which is longer than the above-mentioned shortest time period T0 (S20: Yes, S40). Hereinbelow, the length of the time period T1 is referred to as an extended time period.

The scheduling unit 24 transmits the WdtCTA, which contains the slot specifying information indicating the time slot having the length set in Step S30 or S40, to the device via the transmitting unit 14 (S50). After that, the receiving unit 12 receives data transferred from the device during the slot indicated by the slot specifying information contained in the WdtCTA transmitted in Step S50 (S60).

The device information management unit 22 checks whether or not an error has occurred during the reception of Step S60, and, when the normal reception is performed, the device information management unit 22 resets the reception error count value K of the device to 0 (S70: No, S10). On the other hand, when an error has occurred during the reception of Step S60, the device information management unit 22 increments the reception error count value K of the device by “1” (S70: Yes, S80).

After that, the processing from Step S20 is repeated.

Specifically, in the WUSB system 100 according to this embodiment, when the number of errors which have occurred continuously during the reception of data transferred from a device is equal to or less than the predetermined threshold value, the length of a time slot, which is to be specified for the device, is set to the shortest time period T0, which is necessary for the device to perform data transfer normally. On the other hand, when the number of errors which have occurred continuously during the reception of data transferred from the device exceeds the above-mentioned threshold value, the length of a time slot, which is to be specified for the device, is temporarily extended to the extended time period T1 from the shortest time period T0.

Here, detailed description is given to the significance of such scheduling processing performed by the host device 50. In description and illustration below, the length of a time slot, which is calculated by setting the data length of one packet as the “MaxPacketSize” at that point, is referred to as a “maximum length”. It should be noted that the maximum length and the shortest time period T0 are not always fixed, but are illustrated as fixed values for easy understanding.

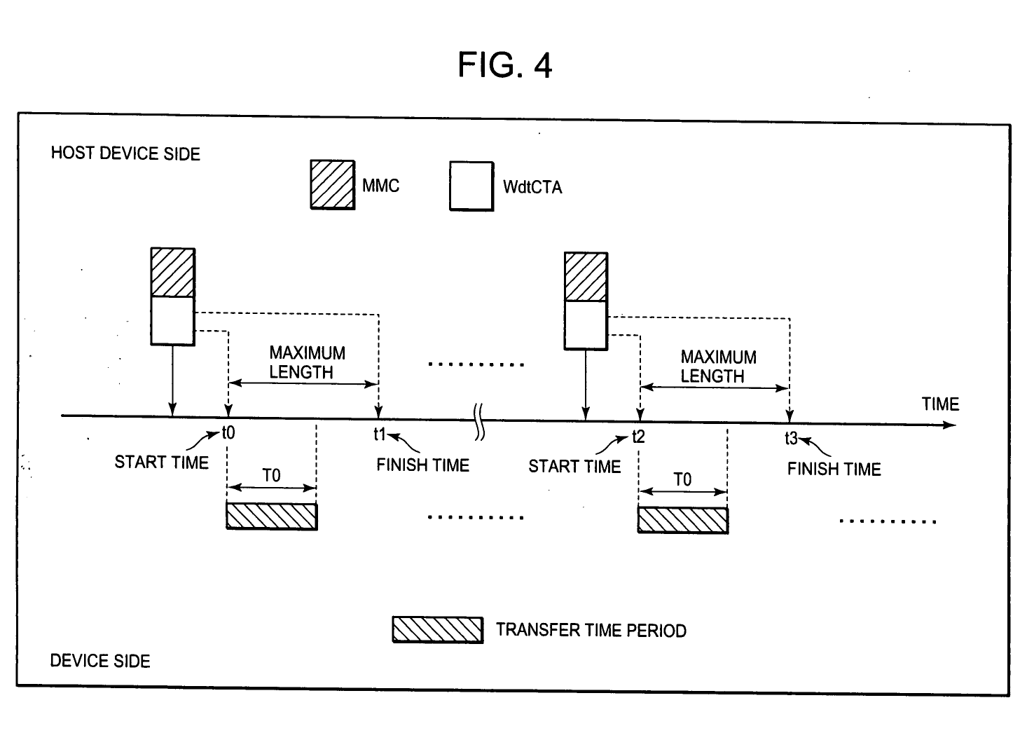

FIG. 4 exemplifies a relation between a slot specified by the host device 50 and a time period necessary for data transfer from the device to the host device 50 for a case where the host device 50 always sets the length of a time slot to the maximum length.

As illustrated in FIG. 4, in response to the WdtCTA from the host device 50, the device starts data transfer to the host device 50 at a start time t0, which is contained in the WdtCTA. In the example of FIG. 4, the packet size of the data is the “ShortPacket” smaller than the “MaxPacketSize”, and a time period necessary for the device to perform data transfer normally is T0, which is shorter than the maximum length. Accordingly, the data transfer is finished before a finish time t1 (t1−t0=maximum length), which is specified by the WdtCTA. The issuance of the WdtCTA by the host device 50 and the data transfer by the device are performed repeatedly. For example, in response to a WdtCTA in which the time slot is specified between a start time t2 and a finish time t3 (t3−t2=maximum length), the device starts data transfer to the host device 50 at the start time t2. In the example of FIG. 4, the packet size of the transfer data is also the “ShortPacket”, which is smaller than the “MaxPacketSize”, and hence the device finishes the data transfer before the finish time t3.

Generally, unless a failure occurs to the device itself or the system, the above-mentioned shortest time period T0 is sufficient for data transfer from the device to the host device 50. Accordingly, if the slot length to be specified for the device is always set to the maximum length as is illustrated in FIG. 4, the time slot is wasted when there are many “ShortPacket” transfers. As a result, a decline in transfer efficiency occurs.

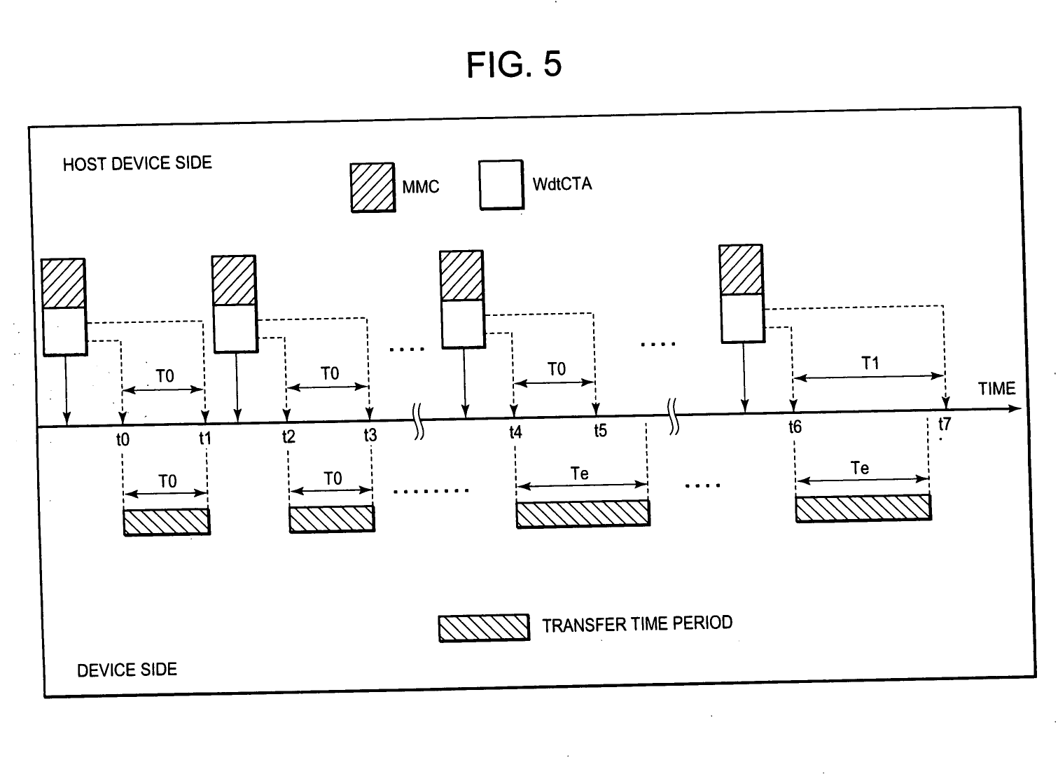

FIG. 5 exemplifies a relation between a slot length specified by the host device 50 and a time period necessary for data transfer from the device to the host device 50 according to this embodiment.

Slots “t0 to t1” and “t2 to t3” represent slots which are specified for the device by the host device 50 when data is received from the device normally or when a reception error has occurred but the number of reception errors which have occurred continuously is equal to or smaller than the predetermined threshold value. As illustrated in FIG. 5, in such a case as described above, the slot length specified by the host device 50 is equal to the shortest time period T0, which is necessary for the device to perform data transfer normally. Accordingly, the data transfer by the device is finished at the finish time of the slot specified by the host device 50. With this configuration, the slot is not wasted as is illustrated in FIG. 4, and hence the efficiency of the system can be improved.

However, due to the influence from the above-mentioned failure or the like, the data length of a packet, which corresponds to the shortest time period T0 (hereinbelow, referred to as expected length), is not always equal to the data length of a packet which the device attempts to transmit. For example, as illustrated in FIG. 5, the issuance of the WdtCTA by the host device 50 and the data transfer by the device are performed repeatedly, and, in response to a WdtCTA specifying a slot “t4 to t5”, the device starts data transfer to the host device 50 at a start time t4. At this point, a time period Te necessary for the device to complete the data transfer is longer than the shortest time period T0. As a result, the device cannot complete the data transfer during the specified slot, and hence a reception error occurs on the host device 50 side.

When the reception error is caused by temporary disturbance, there is a high possibility that, by receiving a WdtCTA issued thereafter and transferring the data again, the device can perform the data transfer normally during the shortest time period T0.

However, when Te is longer than T0 due to the failure of the device itself or the system, that is, when the data length of the packet which the device attempts to transmit is longer than the expected length of the host device 50, the host device 50 needs to notify the driver that an abnormal event has occurred in the system. In order to judge whether the error has been caused by just temporary disturbance to the packet or by the packet containing data longer than the expected length, the host device 50 needs to receive the packet normally. If the host device 50 continues to set the time slot to a length which corresponds to the expected length, a situation in which the device cannot perform data transfer normally continues due to the insufficient time slot length, and then reception errors occur continuously on the host device 50 side. As a result, the above-mentioned judgment cannot be made.

Therefore, the host device 50 of the WUSB system 100 according to this embodiment counts the number of reception errors which have occurred continuously, and, when the count value exceeds the predetermined threshold value, sets the slot length which is to be specified by the slot specifying information to the extended time period T1, which is longer than the shortest time period T0. As illustrated in FIG. 5, a reception error occurs during the slot “t4 to t5”, and the reception error continues to occur thereafter, and hence the host device 50 sets the slot length which is to be specified for the device to T1 (T1=t7−t6). By doing so, the device can transmit the error packet which takes Te to be transferred to the host device 50, which enables the host device 50 to receive that packet to make an error judgment. Hence, it is possible to prevent an error packet transfer caused by a failure from being performed repeatedly, resulting in an improved system efficiency.

Besides, the host device 50 does not change the slot length immediately after one reception error has occurred, but sets a threshold value having a value equal to or larger than 2 and changes the slot length when the number of reception errors which have occurred continuously exceeds that threshold value. With this configuration, such a waste that results from setting the slot longer at the time of temporary disturbance can be prevented, and hence the system efficiency can be further improved.

The present invention has been described above based on the embodiment. The embodiment of the present invention is merely an example, and various changes and modifications may be made without departing from the gist of the present invention. It is understood by those skilled in the art that modification examples added with such changes and modifications also fall within the scope of the present invention.

For example, in the above-mentioned description, the host device 50 changes the slot length from T0 to T1 once. However, the following configuration may also be employed. At the time of the first change, the host device 50 changes the slot length to a length longer than T0, and, if the reception errors occur continuously thereafter, further changes the slot length in stages.

Further, as long as the slot length T1, which is obtained after the change, is equal to or shorter than the maximum length and longer than the shortest time period T0, the advantage of the present invention can be attained using any value.

Further, the embodiment of the present invention is an example in which the technology of the present invention is applied to the WUSB system. The technology of the present invention is applicable to any system in which a host device sets a time slot for data transfer from a device to the host device.

1. A host device, comprising: a scheduling unit which specifies a time slot for transferring data to the host device from a device connected to the host device; and
a receiving unit which receives the data transferred from the device during the time slot specified by the scheduling unit,
wherein the scheduling unit specifies a length of the time slot as a shortest time period necessary for transferring the data normally.

2. A host device according to claim 1, wherein the scheduling unit temporarily sets longer the length of the time slot, which is to be specified for the device, when errors have occurred continuously during data reception from the device, which is performed by the receiving unit.

3. A host device according to claim 2, wherein the scheduling unit temporarily sets longer the length of the time slot, which is to be specified for the device, when a number of the errors which have continuously occurred reaches a predetermined threshold value (threshold value≧2).

4. A host device according to claim 1, which is compliant with a wireless universal serial bus standard.

5. A scheduling method of specifying, by a host device, a time slot for transferring data to the host device from a device connected to the host device, comprising specifying a length of the time slot as a shortest time period necessary for the device to transfer the data normally.

6. A scheduling method according to claim 5, further comprising temporarily setting longer the length of the time slot, which is to be specified for the device, when errors have occurred continuously during data reception from the device.

7. A scheduling method according to claim 6, further comprising temporarily setting longer the length of the time slot, which is to be specified for the device, when a number of the errors which have continuously occurred reaches a predetermined threshold value (threshold value≧2).

8. A scheduling method according to claim 5, wherein the host device and the device are each compliant with a wireless universal serial bus standard.

9. A host device according to claim 2, which is compliant with a wireless universal serial bus standard.

10. A host device according to claim 3, which is compliant with a wireless universal serial bus standard.

11. A scheduling method according to claim 2, wherein the host device and the device are each compliant with a wireless universal serial bus standard.

12. A scheduling method according to claim 3, wherein the host device and the device are each compliant with a wireless universal serial bus standard.

13. A scheduling method according to claim 6, wherein the host device and the device are each compliant with a wireless universal serial bus standard.

14. A scheduling method according to claim 7, wherein the host device and the device are each compliant with a wireless universal serial bus standard.
